(19) United States
(12) Patent Application Publication
(10) Pub. No.: US 2015/0317743 A1
(43) Pub. Date: Nov. 5, 2015

(54) MEDICARE ADVANTAGE RISK ADJUSTMENT

(71) Applicants: Seth Flam, Solana Beach, CA (US); Arnold Mentze, Solana Beach, CA (US); Shawn Terry, Solana Beach, CA (US)

(72) Inventors: Seth Flam, Solana Beach, CA (US); Arnold Mentze, Solana Beach, CA (US); Shawn Terry, Solana Beach, CA (US)

(21) Appl. No.: 14/267,712

(22) Filed: May 1, 2014

(51) Int. Cl. G06Q 40/08; G06Q 10/10; G06Q 50/22

(52) U.S. Cl. CPC G06Q 40/08; G06Q 10/10; G06Q 50/22

(57) ABSTRACT

An apparatus includes a memory and a processor coupled to the memory. The processor may receive a diagnosis input, where the diagnosis input represents a condition of a patient. The processor may also identify a health risk value in a data file stored in the memory using the diagnosis input. In the data file, the diagnosis input is associated with the health risk value. The health risk value is a numerical risk factor that represents an increased risk of treating the patient with the condition. The processor may also calculate a raw risk score based at least in part on the health risk value, where the raw risk score indicates a multiplier that is used at least in part to determine payments to a health care plan.

### BACKGROUND

Medicare is a federal health insurance program. It provides health care in the United States to certain groups of individuals. For example, Medicare provides health care to people who are 65 years of age or older, other younger people with particular disabilities, and other individuals with certain diseases like end-stage renal disease (ESRD). Medicare operates as a social insurance program, and attempts to spread the financial risk of treating illnesses in order to allow coverage for all those enrolled.

Medicare plans do not always cover all the costs of health care, and often those enrolled in a Medicare plan must cover a portion of their health care costs. These “out-of-pocket” expenses can vary for different enrollees. The health care costs that are covered by a given Medicare plan are often paid to the health care provider, similar to how many insurance plans operate.

Medicare has different aspects to it that cover different types of health care and in different ways. Medicare Part A is like hospital insurance, and covers things such as hospital stays and visits, care in a nursing facility, and some hospice and home health care. Medicare Part B is like a Medical Insurance, and covers things such as physicians' services and visits, outpatient care, medical supplies, and preventive services. Medicare Part D is like a prescription drug coverage plan.

Medicare Part C is the Medicare Advantage Plans, and operates more like a Health Maintenance Organization (HMO), but can also include Preferred Provider Organizations (PPO), Private Fee-for-Service Plans, Special Needs Plans, and Medicare Medical Savings Account Plans. Medicare Part C is an alternative to the Part A and Part B plans, and often covers what Part D would as well. In other words, an individual enrolled in Part C may not need to be enrolled in Parts A, B, or D. In contrast, someone not enrolled in Part C may be enrolled in some or all of Parts A, B, and D. Often Medicare Plans under Part C are offered by private companies that contract with Medicare to offer certain benefits.

### SUMMARY

An apparatus includes a memory and a processor coupled to the memory. The processor may receive a diagnosis input, where the diagnosis input represents a condition of a patient. The processor may also identify a health risk value in a data file stored in the memory using the diagnosis input. In the data file, the diagnosis input is associated with the health risk value. The health risk value is a numerical risk factor that represents an increased risk of treating the patient with the condition. The processor may also calculate a raw risk score based at least in part on the health risk value, where the raw risk score indicates a multiplier that is used at least in part to determine payments to a health care plan.

A method includes receiving, by a processor of a computing device, a diagnosis input, where the diagnosis input represents a condition of a patient. The method also includes identifying, by the processor of the computing device, a health risk value in a data file stored in a memory using the diagnosis input. In the data file, the diagnosis input is associated with the health risk value. The health risk value is a numerical risk factor that represents an increased risk of treating the patient with the condition. The method also includes calculating, by the processor of the computing device, a raw risk score based at least in part on the health risk value, where the raw risk score indicates a multiplier that is used at least in part to determine payments to a health care plan.

A non-transitory computer readable medium includes instructions stored thereon for execution by a processor. The instructions include instructions to receive, by the processor, a diagnosis input, where the diagnosis input represents a condition of a patient. The computer readable medium also includes instructions to identify, by the processor, a health risk value in a data file stored in a memory using the diagnosis input. In the data file, the diagnosis input is associated with the health risk value. The health risk value is a numerical risk factor that represents an increased risk of treating the patient with the condition. The computer readable medium also includes instructions to calculate, by the processor, a raw risk score based at least in part on the health risk value, where the raw risk score indicates a multiplier that is used at least in part to determine payments to a health care plan.

### BRIEF DESCRIPTION OF THE DRAWINGS

Illustrative embodiments will hereafter be described with reference to the accompanying drawings.

FIG. 1 is a block diagram illustrating computing devices, a server, and a client-device, that may be used in accordance with an illustrative embodiment.

FIG. 2 is a flow diagram illustrating a method of calculating a raw risk score based on a relative health risk score and/or a demographic risk score in accordance with an illustrative embodiment.

FIG. 3 is a flow diagram illustrating another method of calculating a raw risk score based on a relative health risk score and/or a demographic risk score in accordance with an illustrative embodiment.

FIG. 4 is a flow diagram illustrating a method of calculating a raw risk score when particular relative health risk scores may be nonexistent or superseded in accordance with an illustrative embodiment.

FIG. 5 is a flow diagram illustrating a method of searching for diagnoses and their associated relative health risk scores in accordance with an illustrative embodiment.

FIG. 6 illustrates a user interface used to select diagnoses and utilize the diagnoses in a raw risk score calculation in accordance with an illustrative embodiment.

FIG. 7 is a figure representing a user interface that shows a searched for term, the resulting diagnoses, and their associated relative health scores in accordance with an illustrative embodiment.

FIG. 8 is a figure representing a user interface that shows selected diagnoses and a calculated raw risk score in accordance with an illustrative embodiment.

FIG. 9 is another figure representing a user interface that shows selected diagnoses and a calculated raw risk score in accordance with an illustrative embodiment.

### DETAILED DESCRIPTION

Described herein are illustrative embodiments for a system that calculates risk for treating patients with particular diseases or illnesses. In some health care insurance and maintenance plans, the level of risk involved in treating a patient affects how much a health care provider is paid to treat a patient. In other words, a physician or other health care provider may be paid more to treat a high risk patient than a low risk patient because of the costs of potential complications and the extra care that must be taken when treating a high risk patient. Accordingly, health care plans that use risk levels for adjusting payments to a physician may have a method for quantifying the risk for a patient. Quantifying this risk may be accomplished by using historical treatment data and costs of treating patients with a certain illness to set a risk value for the illness. The risk value represents the inherent risk and cost of treating a patient with the illness. The risk value may then be multiplied by a baseline rate for the treatment performed. The baseline rate may be the average cost of performing the treatment. Some plans may set the baseline rate using geography, resulting in what is called a community rate for performing the treatment. Thus, when a risk value is multiplied by a community rate for the treatment, the payment to a physician or other health care provider may be increased or decreased from the community rate based on the risk value. In such a system, two patients within the same community may have a different payment rate based on the amount of risk or work it takes to maintain the health of a patient.

In an illustrative health care plan, however, the risk multiplier may represent more than just a particular disease being treated by a physician. For example, a more accurate risk multiplier may account for all of the diseases or illnesses that a particular patient has, regardless of whether all of those illnesses are being treated in a particular encounter with a physician. For example, if a patient is being treated for a common flu, treatment of the illness still has increased risk if the patient also has other diseases, such as diabetes. As a result, when treating a patient in a health care plan that incorporates risk into the payment schedule, it is important for a physician or other health care provider to adequately capture all possible diagnoses for a patient when treating them. When all possible diagnoses are captured, the risk scores of all of the illnesses can be utilized to impact the payment to the health care provider. In some plans, the impact to the payments to the health care provider is calculated by adding together the risk values of all of the applicable diseases or illnesses. Once those disease risks are totaled, the summed risk value is then multiplied by the community rate for the service offered. Thus, by adequately capturing diagnoses other than the one being treated, a health care professional can increase the likelihood that a payment for the treatment will be greater than or equal to the community rate for the treatment. In other words, accurately diagnosing a patient may help a physician be properly compensated for the amount of risk the physician encounters when treating the patient.

Some health plans may incorporate other risk factors as well. For example, some health plans may assess risk for treating a patient based on certain demographics of a patient. For example, a health plan may assign certain levels of risk for treating patients of a certain age and gender. These risk levels for demographic characteristics may be set based on historical data for treating patients with similar demographics. In such plans, the risk values based on the demographics may be added to the risk values associated with diagnosed illnesses of the patients. The summed risk score may then be multiplied by the community rate for a particular type of treatment. The summed risk score may be referred to as a raw risk score. The raw risk score is called the raw risk score herein because health plans may apply other factors to a raw risk score for determining a final risk multiplier for adjusting community rate payments. Such other factors may include a statistical normalization factor designed to help normalize payments across an entire health care system and prevent a plan from exceeding budgets. Despite such additional other factors, the raw risk score can still give a relatively good indication of how a community rate for a treatment will be impacted by the diagnoses and demographics of a patient. Thus, the raw risk score may be a valuable piece of information for physicians and health care providers when treating a patient. If a physician can see how the raw risk score, which impacts eventual payments to the physician, is impacted and calculated in real time when diagnosing and treating a patient, the physician may be incentivized to accurately diagnose a patient and treat them accordingly. If a physician sees the raw risk score real time, the physician may provide better treatment to a patient according to their illnesses, and the physician may be better compensated for the increased risk they are exposed to in treating a patient.

Accordingly, disclosed herein are illustrative embodiments for calculating a raw risk score in real time by a health care provider. A raw risk score is generally calculated using a variety of factors. In an illustrative embodiment, a raw risk score is calculated using a demographic risk score and a health status risk score. The demographic risk score may indicate the amount of risk inherent in treating a patient with a particular age and gender. The health status risk score may indicate the amount of risk inherent in treating a patient with particular health issues. Combining the demographic risk score and the health status risk yields a raw risk score.

The raw risk score may form part of an overall risk score. The overall risk score may be used to calculate payments to a health care provider as part of a managed health care benefit plan, such as a health maintenance organization (HMO) or through the Medicare Advantage plans, which will be described in greater detail herein.

In Medicare Advantage (MA), there are several variables that influence how Centers for Medicare and Medicaid Services (CMS) pay out funds to a MA plan. For example, one variable may be a “star rating” of the plan, which is designed to indicate the quality of a particular plan. Another variable may be the geographic location of the plan or the health care providers used by the plan. Yet another factor is related to adjustments based on CMS budgeting.

Other factors for setting rates include a normalization factor and whether the patient is a new or established enrollee. The CMS risk adjustment model is calibrated to normalize the risk scores discussed below to 1.0, to produce a fixed set of dollar expenditures and coefficients appropriate to the population, and data for that calibration year. When the model with fixed coefficients is used to predict expenditures for other years, predictions for prior years are lower and predictions for succeeding years are higher than for the calibration year. Because average predicted expenditures increase after the model calibration year due to coding and population changes, CMS applies a normalization factor to adjust beneficiaries' risk scores so that the average risk score is 1.0 in subsequent years.

A further factor used to set rates paid for plans like MA relate to the role of the physician that is actually seeing and treating patients. If a physician does a good job comprehensively documenting and coding diagnoses, such diligence can positively impact document quality, which may help the plan achieve a higher “star rating.” This is one way a physician may help impact payouts from a system like MA.

Another way the physician has a role in influencing rates also relates to comprehensively diagnosing patients and properly documenting those diagnoses. When a patient is diagnosed with higher risk diseases, this increases the overall risk associated with treating a patient. In other words, the costs of treating a high risk patient are higher than treating a low risk patient. Thus, if a physician does not adequately document the risk factors (diseases) a patient has, the physician may not accurately be reflecting the risk and costs associated with treating that patient.

Medicare Advantage and CMS use a system that reflects these risk factors and increased costs when setting rates for their plans. To document this, the plans utilize a Hierarchical Condition Category (HCC) system. The HCC system is a payment methodology based on “risk” used by CMS to adjust MA health plan payments at the patient level. This means that two different patients within the same community may have a different payment rate based on several factors relating primarily to the amount of risk or work it takes to maintain the health of a patient. When the ultimate risk of a patient is determined, that risk adjustment factor is multiplied by a community rate for the service rendered to determine the amount paid out to a service provider or plan.

There are several factors that impact risk but primarily the HCC risk adjustment is based on the enrollee health status and demographic characteristics. The combination of the health status (H) plus demographic characteristics (D) determines the patient's raw risk score (S) as demonstrated in equation (1) below.

S=H+D (1)

In one embodiment, the age and sex (the primary demographic characteristics used) cannot be changed for a given characteristic. Thus, a physician cannot influence this risk factor. A physician can, however, impact the health status score of a patient through the careful, detailed, and accurate documentation of the patient's health status. This can in turn impact the raw risk score, and help ensure that a physician or health plan is adequately compensated for the risk they encounter when treating a patient.

The health status of a patient is determined using the following methodology for MA: (1) Physicians use diagnosis codes to document health states; (2) In a one-to-many relationship, about 3,000 to 4,000 ICD9 (an international statistical classification of diseases; this is the current standard used although MA may eventually switch to the ICD10 standard) codes relate to around 70-80 HCC Model Categories; (3) Each HCC Model Category relates to a “relative factor” or health risk score. For example, if a patient has Uncomplicated Diabetes Type 1, the ICD9 code is 25001. The associated HCC Model Category is 19. The associated health risk score is 0.121.

Some approximately 10,000 ICD9 diagnosis codes are excluded from the HCC mapping and therefore have no value with regard to contributing to the risk adjusted health status. In other words, the impact on the health risk score from diagnosis codes excluded from the HCC mapping is zero. In other words, since most codes are excluded from the HCC mapping, most codes have no value with regard to contributing to the risk adjusted health status.

Additionally, some codes cannot be used together. For example, if a patient is diagnosed with two particular codes that each have associated health risk scores, only one of them will count toward the risk adjusted health status score. In other words, if two HCC Model Categories are used on the same patient, the risk adjusted health status will exclude one of the codes in the calculation. This is calculated using the HCC model categories. If there is a diagnosis in a particular HCC model category, it will exclude diagnoses from other HCC model categories. For example, from the 2014 Preliminary Disease Hierarchies for the CMS-HCC Model, a particular disease may be mapped to the HCC model category 71 for paraplegia. If there is a diagnosis in the paraplegia 71 category, any other diagnoses in three other HCC model categories are excluded when calculating an adjusted risk factor score for the patient. In the case of the paraplegia 71 HCC model category, the three excluded categories include HCC model categories spinal cord disorders/injuries 72; monoplegia, other paralytic syndromes 104; and vertebral fractures without spinal cord injury 169.

In some embodiments, there may be a limit as to how many codes can be included in a raw risk score calculation. For example, using the HCC model, only the first 12 billed diagnosis codes are included in the HCC raw risk score calculations. As a result, a physician or other health care provider may bill diagnoses codes in such a way as to move higher risk diagnoses to the top of a bill.

An example of how a raw risk score may be calculated is included herein. As noted herein, a raw risk score is not necessarily a final multiplier of the community rate to solve for the final payment for services rendered in a healthcare plan. There are many other factors, some of which are mentioned above, that can impact the final CMS payment with regard to the HCC scoring system. Often, these additional factors may reduce the ultimate risk score and cause it to be slightly lower than the raw risk score.

As an example, a woman can visit a physician with symptoms of a urinary tract infection (UTI). She may be 85 years old. Her history of the present illness (HPI) includes reports of being tired, having less energy, and having a poor appetite. She also reports having a myocardial infarction (MI or heart attack) one year ago. She may also have mild malnutrition, be frail, and have lost 30 pounds in the past six months. Urinalysis may be performed which shows white cells, leukocyte esterase, and microalbuminuria, and a serum creatinine level of 1.4. The patient may be complaining of urinary discomfort, weakness, and may have dry and itchy skin for the past six months. Her past medical history (PMH) may include stable diabetes mellitus (DM), chronic kidney disease (CKD) exacerbated by diabetes, stable below knee amputation (BKA), stable history of MI, a UTI with serum creatinine level 1.3 six months ago, and lab findings revealing a CKD stage 3. The physician may develop a plan for the patient involving a glucophase for the DM, Cipro for the UTI, supplements for the malnutrition, instruction to return to the clinic (RTC) in three months, and referral of the patient to a nephrologist for the CKD stage 3.

In this example, there are numerous things that should be properly documented to ensure the risk of treating such a patient is adequately captured. A poor documentation example for this patient and a potential CMS rate is shown in Table 1 Below.

TABLE 1

| | | Relative Factor | | | Total Payment: $800 |
|---|---|---|---|---|---|
| | ICD9 | (health risk) | Demographic | Raw Risk | (community rate) × |
| Condition | Code | score | Score | Score | risk score |
| DM | 250.00 | 0.162 | 0.44 (85 y/o F) | 0.602 | $481.60 |

| | | | |
|---|---|---|---|
| UTI | 599.0 | 0.0 | Not Mapped to an HCC Model Category |

Note in Table 2 below how a proper documentation may look and its effect on the CMS rate:

TABLE 2

| | | Relative Factor | | | Total Payment: $800 |
|---|---|---|---|---|---|
| | ICD9 | (health risk) | Demographic | Raw Risk | (community rate) × |
| Condition | Code | score | Score | Score | risk score |
| DM w/renal | 250.40 | 0.508 | 0.44 (85 y/o F) | 3.094 | $2,475.20 |
| manifestations | | | | | |
| UTI | 599.0 | 0.0 | | | |
| Diabetic | 583.81 | Trumped by | | | |
| Nephropathy | | CKD Stage 3 | | | |
| CKD Stage 3 | 585.3 | 0.368 | | | |
| Mild Degree | 263.1 | 0.856 | | | |
| Malnutrition | | | | | |
| Old MI | 412 | 0.244 | | | |
| Status Amput | V49.75 | 0.678 | | | |
| Below Knee | | | | | |

As is evident, the raw risk score and resulting potential total payment is much higher when the conditions are documented properly. Note that the diabetic nephropathy is not scored because that condition is trumped or superseded by CKD Stage 3. In situations where one code trumps/supersedes another code, the patient is not credited with both relative factors and the HCC system defines which codes are not scored together. As discussed above, the raw risk score is not necessarily a final multiplier of a community rate that may be paid out by CMS, rather the raw risk score is a valuable tool for estimating how a proper diagnosis can impact the final multiplier and the resulting rate that may be paid out by CMS. To arrive at the raw risk score, all the relative health factor scores can be added (2.654 in this example) to the demographic risk score (0.44) to yield the raw risk score of 3.094.

As a result, embodiments disclosed herein demonstrate how to calculate the raw risk score, to help a provider, physician, or other healthcare professional determine how accurate diagnoses may impact future rates and payments out of certain health care plans.

Various embodiments disclosed herein provide an interface, software, and/or hardware for: (1) determining if an ICD code used to code a condition during a patient visit matches an HCC model category; (2) matching the HCC model category to the relative factor (health risk) score; (3) totaling the health risk score; (4) adding the demographic score; and (5) removing any codes that are being “trumped” or “superseded” by other codes.

Accordingly, a user will be able to see in real time how the various diagnoses and coding impacts potential payment from a health plan. A physician may even be able to code the diagnosis for the patient visit in real time while interacting with the patient. This may be accomplished on a mobile device such as a smart phone or tablet, or any other sort of computing device. Additionally, a health care provider can recognize that a raw risk score of less than 1 will generally adjust the CMS payment for the service rendered below the community rate for the service.

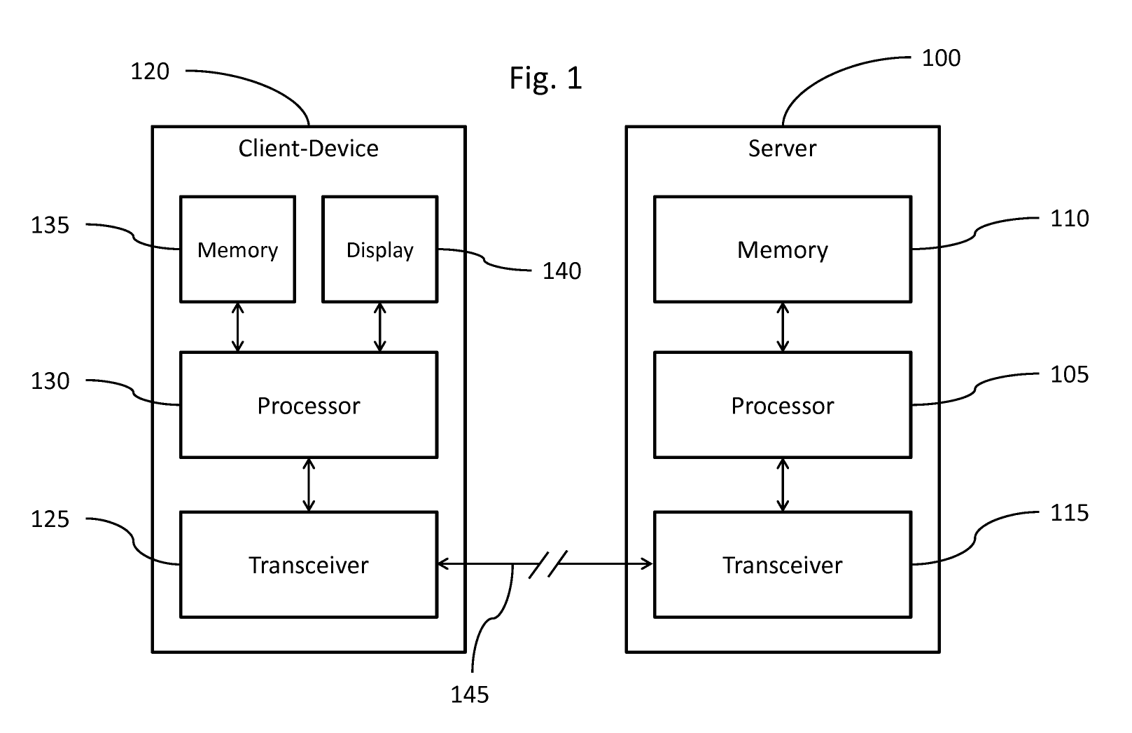

FIG. 1 is a block diagram illustrating computing devices, a server, and a client-device that may be used in accordance with an illustrative embodiment. In FIG. 1, there is both a client-device 120 and a server 100. The server includes a processor 105 that is coupled to a memory 110. The processor 105 can store and recall data and applications in the memory 110. The processor 105 is also coupled to a transceiver 115. With this configuration, the processor 105, and subsequently the server 100, can communicate with other devices, such as the client-device 120 through a connection 145.

The client-device 120 includes a processor 130. The processor is coupled to a memory 135 and a display 140. The processor 130 can store and recall data and applications in the memory 135. The processor 130 may also display objects, applications, data, etc. on the display 140. The processor 130 is also coupled to a transceiver 125. The transceiver 125 allows the processor 130 of the client-device 120 to communicate with the transceiver 115 of the server 100 through the connection 145.

The devices shown in the illustrative embodiment may be utilized in various ways. For example, the connection 145 may be varied. The connection 145 may be a hard wired connection. A hard wired connection may involve connecting the client-device 120 and the server 100 through a USB (universal serial bus) port, serial port, parallel port, or other type of wired connection that can facilitate the transfer of data and information between the processor 130 of the client-device 120 and the processor 105 of the server 100. In another embodiment, the connection 145 may be a dock where the client-device 120 can plug into the server 100. While plugged into a dock, the client-device may also have its batteries charged or otherwise be serviced. In another embodiment, the connection 145 may be a wireless connection. This could take the form of any sort of wireless connection, including but not limited to Bluetooth connectivity, Wi-Fi connectivity, or another wireless protocol. In yet another embodiment, the client-device 120 may connect with the server 100 through an internet (or other network) connection. That is, the connection 145 may represent several different computing devices and network components that allow the client-device 120 and the server 100 to communicate through the internet. The connection 145 may also be a combination of several modes of connection.

To operate different embodiments of the system or programs disclosed herein, the client-device 120 and the server 100 may communicate in different ways. For example, the client-device 120 may download a program from the server 100. The program referred to herein may perform some or all of the processes and functions described herein.

In one embodiment, a download of the program to the client-device 120 involves the processor 130 receiving data through the transceiver 125 from the transceiver 115 of the server 100. The processor 130 may store the data (like the program) in the memory 135. The processor 130 can execute the program at any time. In another embodiment, some aspects of the program may not be downloaded to the client-device 120. For example, the program may be an application that accesses additional data or resources located in the server 100. In another example, the program may be an internet-based application, where the program is executed by a web browser and stored almost exclusively in the server 100. In the latter example, only temporary files and/or a web browser may be used on the client-device 120 in order to execute the program, system, application, etc.

In yet another embodiment, once downloaded to the client-device 120, the program may be able to operate without communication with the server 100. In this embodiment, the client-device 120 may access or communicate with the server 100 only when acquiring the program, system, application, etc. through the connection 145. In other embodiments, a constant or intermittent connection 145 may exist between the server 100 and the client-device 120.

The configuration of the server 100 and the client-device 120 is merely one physical system on which the disclosed embodiments may be executed. Other configurations of the devices shown may exist to practice the disclosed embodiments. Further, configurations of additional or fewer devices than the ones shown in FIG. 1 may exist to practice the disclosed embodiments.

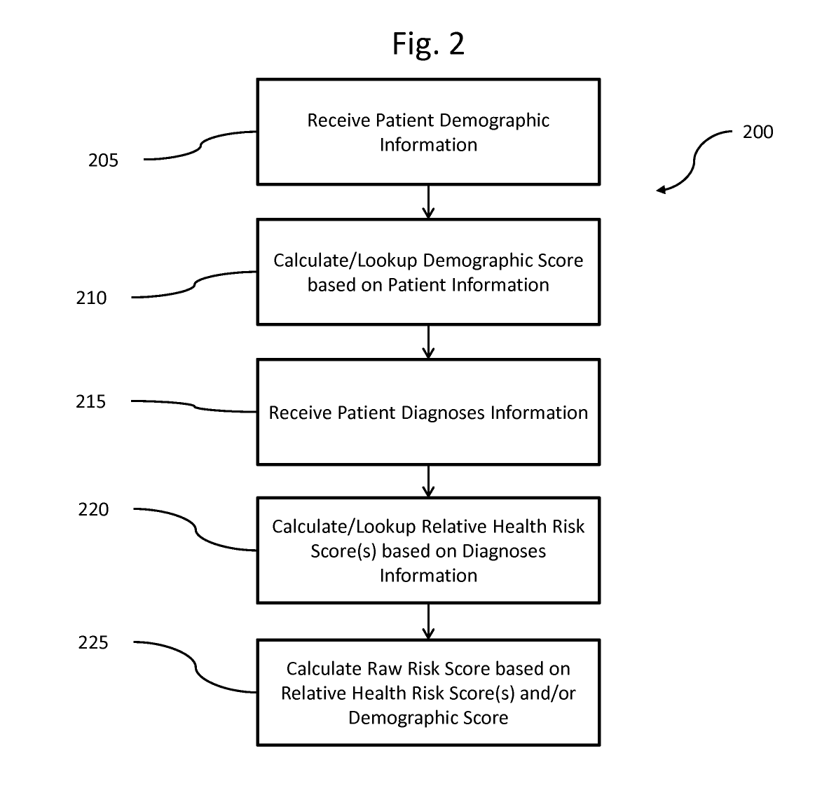

FIG. 2 is a flow diagram illustrating a method 200 of calculating a raw risk score based on a relative health risk score and/or a demographic risk score in accordance with an illustrative embodiment.

In element 205, patient demographic information is received. The patient demographic information can include many different types of demographic information. For example, the patient demographic information may include the age of a patient, the gender of a patient, the height of a patient, and/or any other demographic piece of information.

In element 210, a demographic risk score based on the patient demographic score is acquired. The demographic risk score may be looked up in a data table based on the input demographic information. For example, data representing a look-up table may include demographic risk scores for different individuals based on their age and gender. In another embodiment, the demographic risk score may be calculated using particular formulas, equations, or functions, etc. Regardless of the method used to calculate or look up the demographic risk score, the demographic risk score may be represented by a single numerical value.

In element 215, patient diagnoses information is received. Patient diagnoses information may be input by a physician. The physician may input the information during an encounter with a patient. As the physician examines the patient, the physician may discover additional diagnoses information to update the system with. A physician may also review a patient's medical history to discover other potential diagnoses information, particularly diagnoses information that relates to a long term or recurring condition. A physician may also enter diagnoses information before or after an encounter with a patient. A physician may particularly want to enter diagnoses information during or right after an encounter with a patient. A physician may enter diagnoses information during or right after an encounter because the encounter with the patient and the patient's medical issues will be fresh in the physician's mind. Accordingly, the physician may find it easier to diagnose and enter codes for a patient. In other embodiments, the patient diagnoses information may be entered in the same manner as a physician by another individual, such as a nurse, a nurse practitioner, an administrative assistant, or a person responsible for billing. Additionally, diagnoses information may be received from a computing device or data storage server. For example, medical records are often stored in electronic files. Therefore, diagnoses, especially past diagnoses may be received from applications or devices that store or have access to medical records. In another embodiment, the diagnoses information may be received when the system searches for particular diagnoses or medical records in an electronic database. In another embodiment, the diagnoses information may be received from a computing device, but the information may have been input into the computing device by a physician, nurse, nurse practitioner, or other health care professional. The patient diagnoses information may include information relating to an ailment, illness, or condition of the patient. Such an ailment, illness, or condition may be long-term and on-going, or the ailment, illness, or condition may be a shorter-term present illness. The illness, ailment, or condition of the patient may also be a former illness, ailment, or condition of the patient. If the illness, ailment, or condition of the patient is ongoing, the patient may or may not be displaying symptoms when the patient diagnoses information is entered at element 215. The patient diagnoses information received may be the name of the illness, ailment, or condition, or may be a code that indicates an illness, ailment, or condition. For example, an ICD (International Classification of Diseases) code may be used to indicate the illness, ailment, or condition. Other coding schemes may also be used in accordance with various embodiments.

In element 220, a relative health risk score is looked up or calculated based on the patient diagnoses information received about the patient. Similar to element 210, the relative health risk score may be looked up or calculated. If the relative health risk score is looked up, it may exist in a data table stored in a memory. If the relative health risk score is calculated, a formula or factors may exist in the memory that aid in calculating the relative health risk score. In an illustrative embodiment, a particular illness, ailment, or condition of the patient is associated with a particular relative health risk score. The health risk score represents the added risk of treating a patient with the particular illness, ailment, or condition. If a patient has multiple illnesses, ailments, or conditions, the relative health risk score may be the combination of the relative health risk scores associated with each ailment, condition, or illness associated with the patient. In this way, the total relative health risk score represents a risk of treating a patient with a particular combination of issues. In an illustrative embodiment, the relative health risk score is represented by a single numerical value (after the relative health risk scores for each issue is added together, if there are multiple issues for a patient).

In element 225, a raw risk score is calculated based on the relative health risk score and the demographic risk score. In an illustrative embodiment, the raw risk score is the relative health risk score combined with the demographic risk score. In other embodiments, the raw risk score may use a formula incorporating the values of the relative health risk score and/or the demographic risk score. In an alternative embodiment, only one of the relative health risk score and the demographic risk score may be used to calculate the raw risk score. In yet another alternative embodiment, additional factors or risk scores may be incorporated to yield the raw risk score.

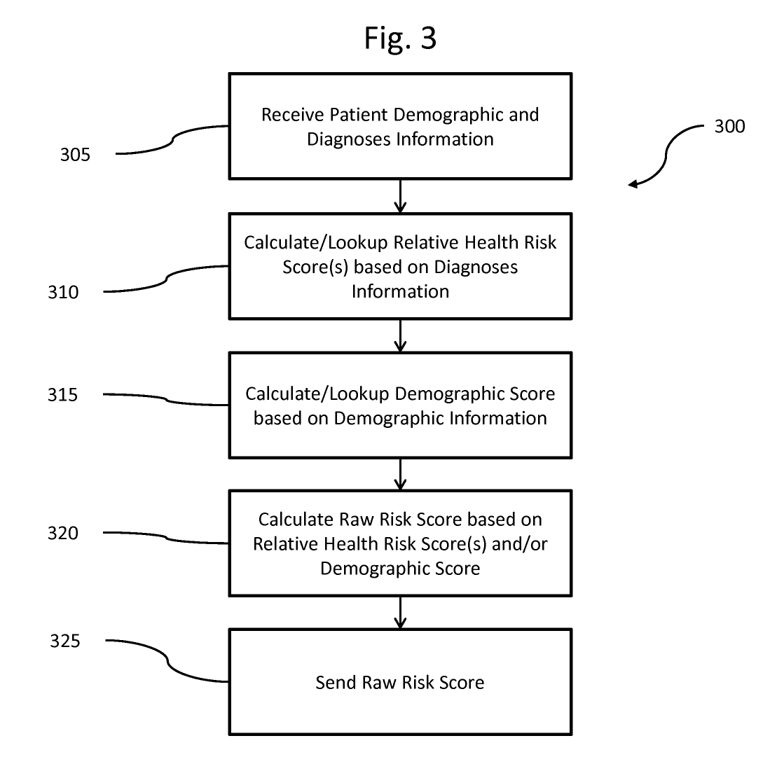

FIG. 3 is a flow diagram illustrating another method 300 of calculating a raw risk score based on a relative health risk score and/or a demographic risk score in accordance with an illustrative embodiment.

In element 305 of FIG. 3, patient demographic information and patient diagnoses information is received. The patient demographic information may be many different types of demographic information. For example, the demographic information may be the age of a patient, the gender of a patient, the height of a patient, or any other demographic piece of information. The patient diagnoses information may include information relating to an ailment, illness, or condition of the patient. Such an ailment, illness, or condition may be long-term and on-going, or the ailment, illness, or condition may be a shorter-term present illness. The illness, ailment, or condition of the patient may also be a former illness, ailment, or condition of the patient. If the illness, ailment, or condition of the patient is ongoing, the patient may or may not be displaying symptoms when the patient diagnoses information is received at element 305. The patient diagnoses information received may be the name of the illness, ailment, condition, etc., or may be a code that indicates an illness, ailment, condition, etc. For example, an ICD (International Classification of Diseases) code may be used to indicate the illness, ailment, or condition. Other coding schemes may also be used in accordance with various embodiments.

In element 310, a relative health risk score is looked up or calculated based on the patient diagnoses information received. If the relative health risk score is looked up, it may exist in a data table stored in a memory. If the relative health risk score is calculated, a formula or factors may exist in the memory that aid in calculating the relative health risk score. In an illustrative embodiment, a particular illness, ailment, or condition of the patient is associated with a particular relative health risk score. If a patient has multiple illnesses, ailments, or conditions, the relative health risk score may be the combination of the relative health risk scores associated with each ailment, condition, or illness associated with the patient. In this way, the total relative health risk score represents a risk of treating a patient with a particular combination of issues. In an illustrative embodiment, the relative health risk score is represented by a single numerical value (after the relative health risk scores for each issue is added together, if there are multiple issues for a patient).

In element 315, a demographic risk score is calculated or looked up based on the demographic information received. The demographic risk score may be looked up in a data table based on the input demographic information. For example, data representing a look-up table may include demographic risk scores for different individuals based on their age and gender. In another embodiment, the demographic risk score may be calculated using particular formulas, equations, or functions, etc. Regardless of the method used to calculate or look up the demographic risk score, the demographic risk score may be represented by a single numerical value.

In element 320, a raw risk score is calculated based on the demographic risk score and the relative health risk score. In an illustrative embodiment, the raw risk score is the relative health risk score combined with the demographic risk score. In other embodiments, the raw risk score may use a formula incorporating the values of the relative health risk score and/or the demographic risk score. In an alternative embodiment, only one of the relative health risk score and the demographic risk score may be used to calculate the raw risk score. In yet another alternative embodiment, additional factors or risk scores may be incorporated to yield the raw risk score. For example, a health plan may use a normalization factor. The normalization factor may be calibrated to normalize risk scores to 1.0, which may be intended to produce a fixed set of dollar expenditures and coefficients appropriate to the population and data for a calibration year. In other words, a health plan may try to adjust all raw risk scores so that the average risk score is 1.0 in a given year. Adjusting risk scores in this manner may help a health plan control costs and meet a budget. Additionally, whether a patient is a new or established enrollee may be used as a factor to affect a final risk score.

In element 325, the raw risk score is sent. In an illustrative embodiment, the raw risk score may be sent to a display. Displaying the raw risk score to a health care provider like a physician, billing staff-person, or other health care professional may be helpful. By viewing the displayed raw risk score, a health care professional can better understand how the diagnoses of a particular patient will affect the raw risk score, and subsequently how the diagnoses of a particular patient will affect payments to the health care professional. In another embodiment the raw risk score may be sent to another software application. For example, the raw risk score may be sent to a software application used for coding and billing of conditions for patients. In another example, the raw risk score may be stored in a database for record-keeping purposes. If stored, the raw risk score may also be stored with the relevant patient diagnoses information that was used to determine the relative health risk score and subsequently the raw risk score. In this manner, if a patient is seen again by the health care provider, certain recurring or ongoing conditions may be recalled, allowing for easier diagnoses and more accurate coding in the future.

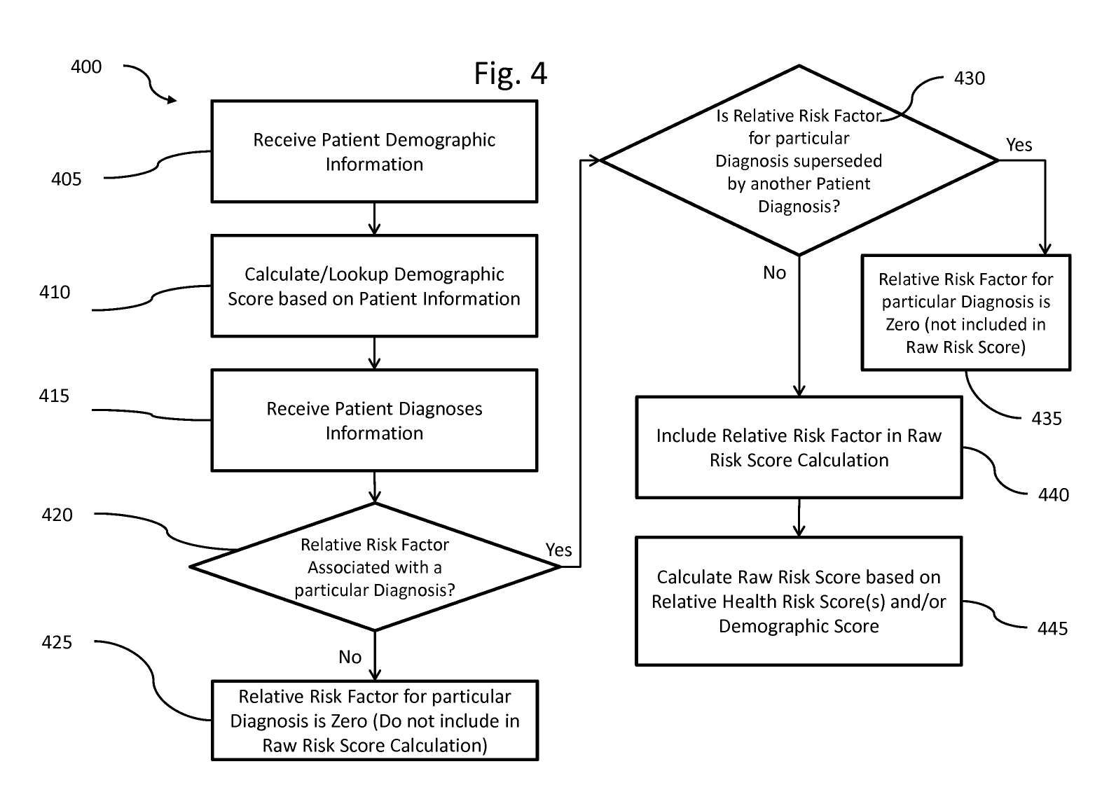

FIG. 4 is a flow diagram illustrating a method 400 of calculating a raw risk score when particular relative health risk scores may be nonexistent or superseded in accordance with an illustrative embodiment.

In element 405, patient demographic information is received. In an illustrative embodiment, element 405 is similar to element 205 of FIG. 2. In element 410, a demographic risk score is calculated or looked up based on the patient demographic information. In an illustrative embodiment, element 410 is similar to element 210 of FIG. 2.

In element 415, patient diagnoses information is received. In an illustrative embodiment, element 415 is similar to element 215 of FIG. 2. The patient diagnoses information may include information relating to an ailment, illness, or condition of the patient. Such an ailment, illness, or condition may be long-term and on-going, or the ailment, illness, or condition may be a shorter-term present illness. The illness, ailment, or condition of the patient may also be a former illness, ailment, or condition of the patient. If the illness, ailment, or condition of the patient is ongoing, the patient may or may not be displaying symptoms when the patient diagnoses information is received at element 415. As discussed above in regards to element 215 of FIG. 2, the patient diagnoses information may be received in a variety of ways from a variety of sources. The patient diagnoses information received may be the name of the illness, ailment, or condition, or may be a code that indicates an illness, ailment, or condition. For example, an ICD (International Classification of Diseases) code may be used to indicate the illness, ailment, or condition. Other coding schemes may also be used in accordance with various embodiments.

Upon receiving the patient diagnoses information in element 415, the system determines in element 420 whether there is a relative health risk factor associated with the particular diagnoses input in element 415. If there is not a relevant health risk factor associated with a particular diagnosis, the relative health risk factor is zero as demonstrated by element 425 (or in the alternative the diagnosis is simply not included in raw risk score calculation, yielding the same result). Element 425 accounts for when, in a disease coding system, there are codes that do not have inherent relative health risk factors associated with them. In a further embodiment, a system may alert a health care provider if a code without a relative health risk factor is being used with a given patient. For example, after the code without a relative health risk factor is received, the system may alert the user with a warning message. The warning message may appear as a warning message on the display page the user is already viewing. Alternatively, the system may display a separate warning page warning the user. The system may also warn the user with an audible warning sound. In another embodiment, the warning may be an e-mail, text message, or other electronic message. A warning electronic message may be sent to the user, such as a physician, or it may be sent to another party, such as a billing staff person. If the warning is sent to a billing staff person, a billing staff person may be able to follow up with a physician to verify that a code with no relative health risk factor should be actually be used for billing. The follow up may be done in person or may be implemented by the system. For example, when the electronic message is sent to the billing staff person, the billing staff person may have the option to send a message to the physician asking about the code and/or asking for a verification that the code should be used. The physician may then be able to input and send a response verifying that the code should be used, or in the alternative that a different code should be used. Similarly, a system may also alert a health care provider to similar disease codes to the one entered that actually have a relative health risk factor associated with it.

If the system determines in element 420 that there is a relative health risk factor associated with a particular diagnosis input from element 415, the system proceeds to element 430. In element 430, the system considers whether a particular diagnosis input is superseded by another inputted patient diagnosis. In some hierarchical condition category (HCC) systems, certain diseases are superseded by others for the purposes of calculating raw risk scores. A disease or diagnosis may be superseded if, for example, it is quite similar to another disease code or diagnosis already inputted. This may prevent an unnecessary “doubling up” of the relative health risk factors where a patient has related or similar diseases or symptoms. When diseases or diagnoses are superseded, it is ultimately supposed to more accurately reflect the inherent risk of treating the patient with the related diseases. In an illustrative embodiment, the health plan will design the HCC codes to incorporate superseding of certain disease codes. In other words, by referring to a database of data containing information of a particular health plan, the system can determine whether a disease code is superseded by another disease code.

If, in element 430, it is determined that a particular diagnosis is superseded by another patient diagnosis, then the relative health risk factor for the particular diagnosis is considered to be zero as demonstrated by element 435 (or, in the alternative, the relative health risk factor simply is not used to calculate the raw risk score, with both alternatives having the same effect).

Otherwise, if in element 430, the diagnosis and its associated relative health risk factor are not superseded by another diagnosis, the relative health risk factor is included in the raw risk score calculation, as demonstrated in element 440. When the relative health risk factor(s) are considered and determined for inclusion in the raw risk score calculation, the raw risk score is actually calculated as demonstrated by element 445. The raw risk score is calculated using the relative health risk scores as determined by the rest of the elements of the method 400, as well as the demographic risk score determined in element 410. In an illustrative embodiment, the raw risk score is the relative health risk score combined with the demographic risk score. In other embodiments, the raw risk score may use a formula incorporating the values of the relative health risk score and/or the demographic risk score. In an alternative embodiment, only one of the relative health risk score and the demographic risk score may be used to calculate the raw risk score. In yet another alternative embodiment, additional factors or risk scores may be incorporated to yield the raw risk score.

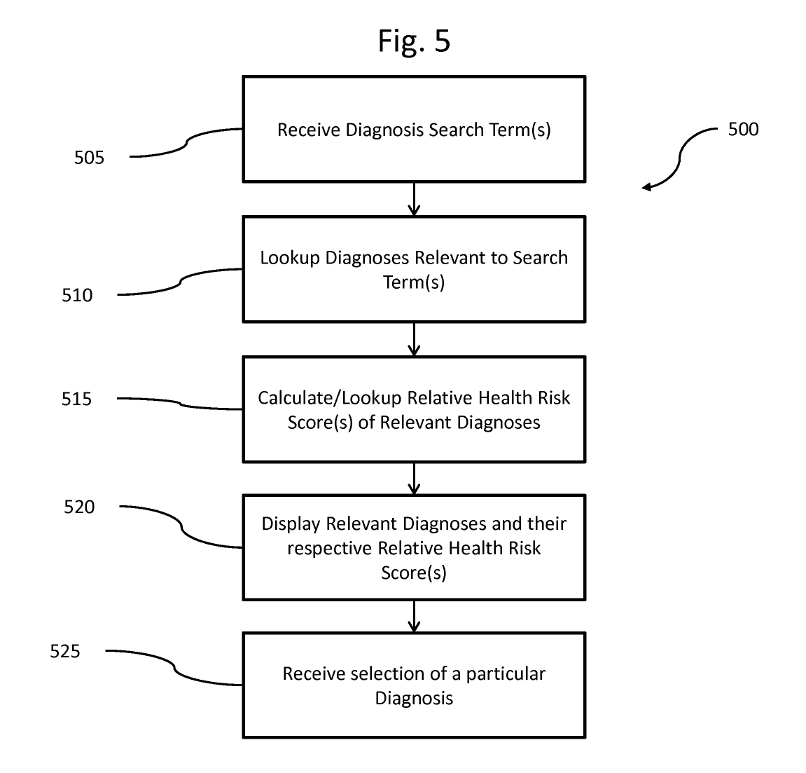

FIG. 5 is a flow diagram illustrating a method 500 of searching for diagnoses and their associated relative health risk scores in accordance with an illustrative embodiment.

In element 505 of the method 500, a diagnosis search term is received. For example, such an input may be “diabetes” or “asthma.” An alphanumeric code may also be entered as a search term.

In element 510, the system performs a lookup or search of diagnoses relevant to the search term(s). For example, if “diabetes” was the search term, all the diagnoses including the word “diabetes” or known to be related to diabetes may be returned as search results. Further, in element 515, all the relative health risk scores of the returned diagnoses in the search are also looked up or calculated. Upon determining all the relevant diagnoses and their associated relative health risk scores in elements 510 and 515, the relevant diagnoses and their respective relative health risk scores are displayed in element 520.

The relevant diagnoses and respective relative health risk scores are displayed in element 520 in order to allow a health care provider or billing professional too quickly, easily, efficiently, and in real time select an appropriate diagnosis that accurately reflects the appropriate relative health risk score. As a result, upon displaying the results of the search/lookup in element 520, the system can subsequently receive a selection or selections of a particular diagnosis or diagnoses in element 525. Using method 500, a health care provider may be able to accurately locate and code diagnoses in real time while examining a patient.

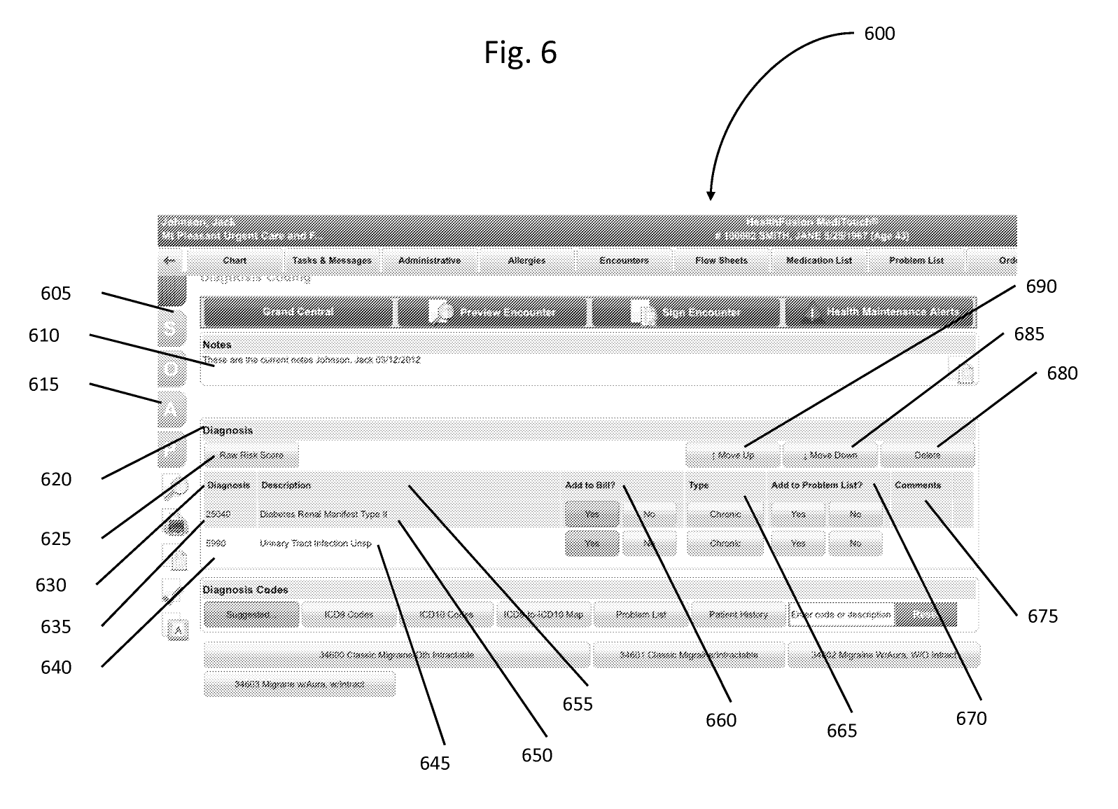

FIG. 6 is illustrates a user interface 600 used to select diagnoses and utilize the diagnoses in a raw risk score calculation in accordance with an illustrative embodiment. The user interface 600 includes a navigation pane 605. The navigation pane includes at least four tabs, one for each of the letters in the acronym SOAP. The letters in the acronym indicate different facets of a diagnosis for a patient. The “S” stands for the subjective analysis and observation of a patient. The “O” stands for the objective analysis and observation of a patient. The “A” stands for the assessment of the patient's condition. Finally, the “P” stands for the plan to be developed to treat the patient going forward. Included in the navigation pane is a tab 615. The tab 615 is the “A,” or assessment tab. In this embodiment, navigating to the tab 615 will allow a health care provider or other user to access the user interface 600 for selecting and utilizing diagnoses in a raw risk score calculation.

In the user interface 600, a notes section 610 is included. The notes section 610 allows the user to make certain anecdotes or other relevant facts about the visit. For example, a physician seeing a patient may wish to note the date, purpose of visit from the patient, or reasons for selecting particular diagnoses codes over others.

The user interface 600 also includes a diagnosis pane 620. The diagnosis pane displays, in a diagnosis column 630, a first selected diagnosis code 635 and a second selected diagnosis code 640. These selected diagnosis codes may have been entered by a user manually, or may have been selected as the result of a search for diagnoses codes in a process disclosed herein. The first selected diagnosis code 635 and the second selected diagnosis code 640 are selected if they might be applicable diagnoses for a patient.

The first selected diagnosis code 635 includes a first text description 650 in a description column 655. The first text description 650 gives a brief indication of the disease the first selected diagnosis code 635 represents. Likewise, a second text description 645 gives a brief indication of the disease the second selected diagnosis code 640 represents.

The diagnosis pane 620 also includes an “Add to Bill?” column 660. The “Add to Bill?” column 660 includes two buttons for each row associated with the first selected diagnosis code 635 and the second selected diagnosis code 640. The “Add to Bill?” column 660 includes a yes button and a no button on each row. A selection of the yes button can include the associated diagnosis and billing code with a bill. If no is selected, the diagnosis will not be included in the bill. Adding a diagnosis to a bill may be helpful for billing, particularly if the system is connected to a billing department or medical records systems.

The diagnosis pane 620 also includes a type column 665 and an “Add to Problem List?” column 670. The type column 665 includes a toggle button that can be switched on and off. If the button is selected, the user is indicating that the applicable diagnosis or condition is chronic. If the button is not toggled on, the user is indicating that the condition is not chronic, or at least is not chronic at this time. This may be helpful for identifying conditions in the future that may be applied to a patient and used to calculate a raw risk score. Similarly, the “Add to Problem List?” column 670 may be important for similar purposes. The system may maintain a problem list of diagnoses that may be a recurring issue for a particular patient. In this manner, a problem list may be referred to on subsequent visits to remind a health care provider that there are billing codes and diagnoses that may apply to the calculating of the raw risk score that are on the problem list.

A comments column 675 is also found in the diagnosis pane 620. This is a space where a health care provider or other user may add any comment deemed relevant to a particular diagnosis or diagnosis code. A user may also add a comment to explain why a diagnosis was selected, or why certain selections were made in the “Add to Bill?” column 660, the type column 665, or the “Add to Problem List?” column 670.

Also included in the diagnosis pane 620 are a delete button 680, a move down button 685, and a move up button 690. These three buttons are used to arrange or edit the diagnoses rows in the diagnosis pane 620 previously discussed. The delete button 680 may be used to delete a selected diagnosis and remove it from the diagnosis pane 620. The move down button 685 and the move up button 690 may be used to rearrange the order of the diagnoses appearing in the diagnosis pane 620. Rearranging the diagnoses in the diagnosis pane 620 may be helpful if a user wants to prioritize the more important, more urgent, or higher risk diagnoses. Additionally, the diagnoses may also be arranged in a way that places similar diagnoses near each other, making for a more coherent interface for users. Another potential advantage for moving diagnoses up and down occurs if the order matters for billing. For example, in some embodiments, there may be a limit on the number of diagnosis codes that count toward the raw risk score. For example, if HCC mapping is used, only the first 12 diagnosis codes may be used to calculate a raw risk score. Therefore, if there are more than 12 diagnosis codes applicable, a physician or other user may move the codes up or down using the move down button 685 and the move up button 690 to arrange diagnosis codes in order to maximize the raw risk score. Additionally, the user interface may display a reminder that only a certain number of billed diagnosis codes are included in the raw risk score calculations. The reminder may help a physician or other user accurately order the billing codes to maximize the raw risk score.

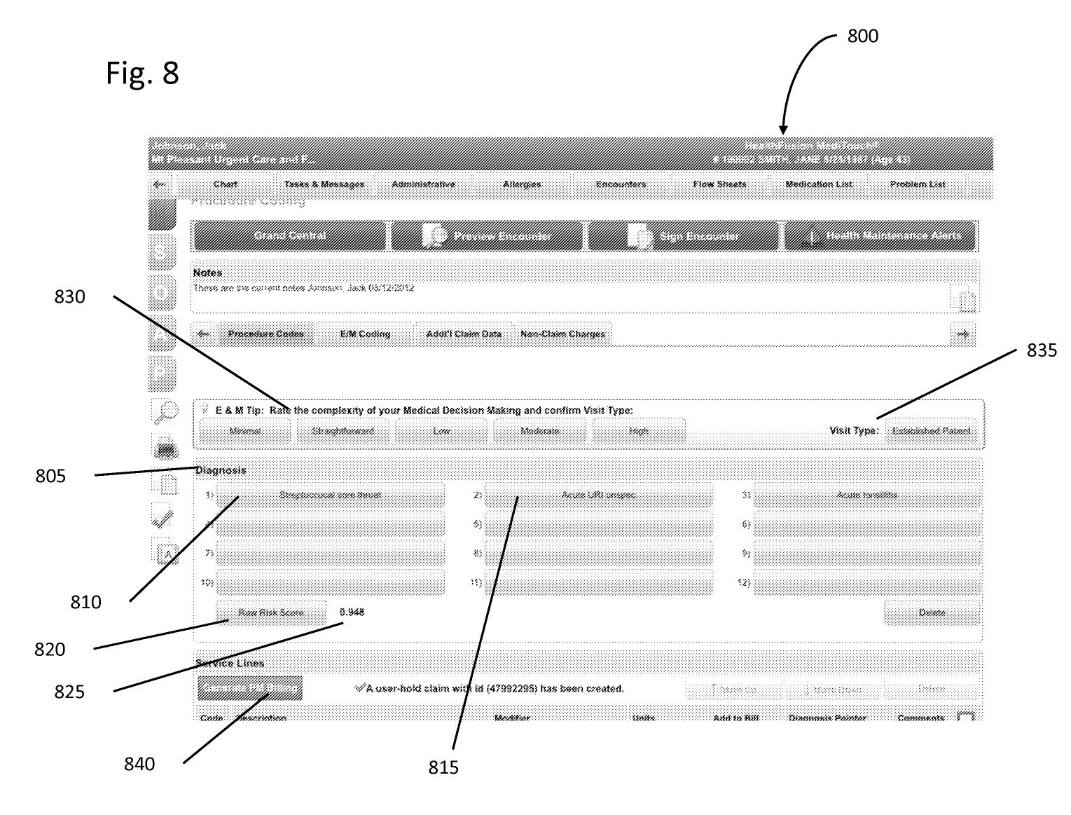

In other embodiments, a diagnosis pane may include more or less diagnoses than the two shown in diagnosis pane 620. A diagnosis pane may also include other additional options not shown in diagnosis pane 620. Different arrangements or embodiments are contemplated to achieve the functionality of the diagnosis pane 620. Further, the diagnoses shown in the diagnosis pane 620 may be used in an interface such as the one shown in FIG. 8 for calculating a raw risk score.

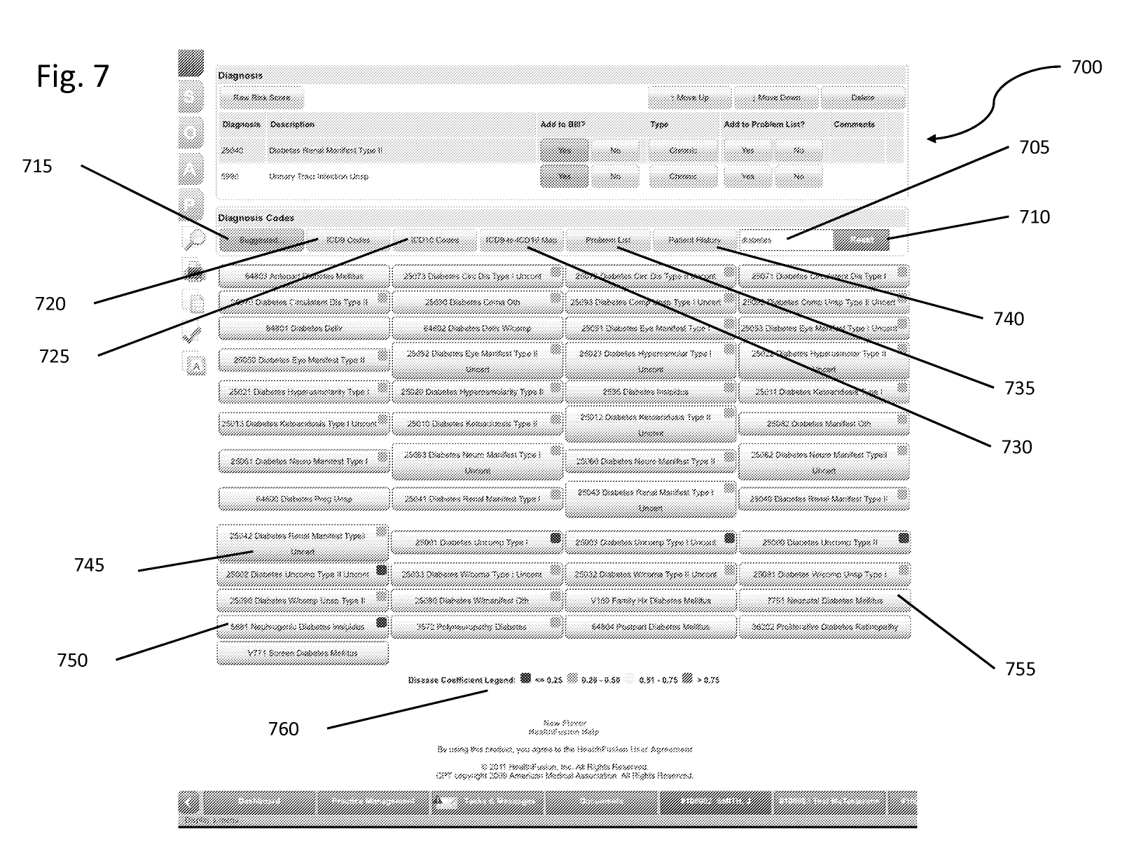

FIG. 7 is a figure representing a user interface 700 that shows a searched for term, the resulting diagnoses, and their associated relative health scores in accordance with an illustrative embodiment.

The user interface 700 shows a diagnosis code search tool. The user interface 700 includes a text entry box 705. A search term or code may be input by a user into the text entry box 705. The user can put in various search terms, such as “diabetes,” as shown in FIG. 7. The user may also put in a code associated with a diagnosis in order to search for it. Once a user has input the desired search term(s) into the text entry box 705, the search fields will populate with search results. The system displays results that are similar or relevant to the search terms. Examples of the search results include diagnosis 745, diagnosis 750, and diagnosis 755, among others. In the event a user would like to clear the text entry box for another search, or clear the results that have populated, a reset button 710 is provided. In another embodiment, a search button may be put in the user interface, allowing the user to control when the system performs the search by pushing the search button.

The user interface 700 includes other navigational and search tools to assist a user in locating diagnoses and their associated codes and relative health risk factors. These tools include a suggested button 715, an ICD9 codes button 720, an ICD10 codes button 725, an ICD9-to-ICD10 map button 730, a problem list button 735, and a patient history button 740.

The suggested button 715 may be selected by a user to populate search results with suggested diagnoses. The populated diagnoses may be suggested for various reasons. For example, suggested diagnoses may be displayed based on the search term(s) entered into the text entry box 705. Other diagnoses may be suggested based on already selected diagnoses, such as the ones in the diagnosis pane 620 shown in FIG. 6. Other suggestions may be made based on the medical history of the patient. Still further suggestions may be made based on results already populated on the page from a separate search.

The ICD9 codes button 720 can also be selected. If selected, the search results populated will show a diagnosis and its associated disease code according to the ICD9 coding standard. Similarly, if the ICD10 codes button 725 is selected, the search results populated will show a diagnosis and its associated disease code according to the ICD10 coding standard.

If the ICD9-to-ICD10 map button 730 is selected, the user interface 700 will demonstrate a link between an ICD9 code and an ICD10 code for one or more diagnoses. This may occur in different ways in different embodiments. First, the populated search results may appear and show both the applicable ICD9 and ICD10 codes for each search result. If a particular search result does not have both an ICD9 and an ICD10 code, the one the diagnosis does not have will be omitted. In another embodiment, selecting the ICD9-to-ICD10 map button 730 may also bring up a graphical map showing the related codes and diagnoses. Other various ways of showing how ICD9 and ICD10 codes correspond to each other are also contemplated. Seeing how these codes correspond may help a user determine proper codes for their diagnoses if different billing structures require different codes. Similarly, if a billing structure switches from one code system to another, it may be helpful to have some way to link the two to aid a user in the time leading up to and after the switchover.

If the problem list button 735 is selected, the search results are populated with diagnoses and codes that have been previously added to a problem list by a user. As noted above with respect to FIG. 6, selected diagnoses can be added to a problem list using buttons in the “Add to Problem List?” column 670. This may be useful for a user when the patient has been seen before. If they have any recurring or ongoing issue, the previous diagnoses and their associated codes can be easily recalled using the problem list button 735. Additionally, the problem list may remind a user to include certain diagnoses of the patient that they might have otherwise forgotten. For example, if a patient has ongoing diabetes issues, but has come in for treatment of a virus, the user (e.g., physician) could forget to diagnose the diabetes issues. In this case, the user could check the problem list and note that the patient has the recurring issues with diabetes and properly diagnose the patient. Similarly, the patient history button 740 may be selected to populate the search results with any past diagnoses of a patient. If the patient history button 740 is selected, all past diagnoses are displayed, without regard to whether they are ongoing issues or whether they have been specifically designated for the problem list. This can be useful for some of the same reasons as the problem list. Past diagnoses can be used to inform a user of potential diagnoses they should be including with a current diagnosis.

As previously mentioned, the populated search results shown in the user interface 700 include the diagnosis 745, the diagnosis 750, and the diagnosis 755, among others. The diagnosis 745 shows a search result for “25042 Diabetes Renal Manifest Typeii Uncert . . . ” The diagnosis 745 therefore includes a short description and the applicable code for the diagnosis. In this case, the code 25042 is the ICD9 code for the diagnosis. The diagnosis 745 also includes a health risk indicator in the upper right corner. The health risk indicator demonstrates an approximate risk factor associated with the diagnosis 745. In this case, the diagnosis 745 is associated with a relative health risk factor between 0.26 and 0.50, as demonstrated by the disease coefficient legend 760. The health risk indicator can assist a health care provider in correctly identifying diagnoses for a patient.

In another example, diagnosis 750 shows a relative health risk factor of less than or equal to 0.25, indicating a lower impact on a raw risk score than the diagnosis 745 would. Diagnosis 755 does not show a health risk indicator, meaning there is not a relative health risk factor associated with the diagnosis. This indicates that if a user selects the diagnosis 755, it would have no impact on the raw risk score calculation.

Any of the populated search results, including the diagnosis 745, the diagnosis 750, and the diagnosis 755, may be selected and displayed in a manner similar to the diagnoses in FIG. 6. Additionally, these search results may be selected for inclusion in a raw risk factor calculation, an example of which is shown and discussed below with regards to FIG. 8. Further, other coding systems than ICD9 or ICD10 may be used.

Such a system may be integrated with a billing or records database or application, such that selecting the patient history button 740 may recall information from a patient's record, regardless of whether the patient has been seen by a particular user of the system or not. Additionally, if the system is integrated with a billing database or application, the inputs and selections of diagnoses by a user may actually be used in billing the services rendered.

In another embodiment, user interface 700 could be varied or modified. For example, instead of health risk indicators shown with various diagnoses, the user interface may display the actual relative health risk factors along with the populated search results. In such an embodiment, the actual relative health risk factors may include the risk score number, and whether it would cause the raw risk score to increase or decrease. For example, if a diagnosis code may cause the raw risk score to increase by 0.141, a 0.141 with an arrow pointing up may appear with a diagnosis. If a code will make the raw risk score go down, it may appear with a down arrow. This may happen, for example, if the raw risk score of a diagnosis code supersedes other diagnosis codes already selected by the user. Additionally, the display of the risk score number may indicate the impact on the raw risk score with color. For example, if a diagnosis code will cause the raw risk score to go up, the background of the risk score number may appear green. In another example, if a diagnosis code will cause the raw risk score to go down, the background of the risk score number may appear red. If a diagnosis code will have no effect on the raw risk score, the risk score number for that code may appear as a zero or as N/A (not applicable). The background for such a risk score number may appear as a color such as brown, gray, or blue.

FIG. 8 illustrates a user interface 800 that shows selected diagnoses and a calculated raw risk score in accordance with an illustrative embodiment.

The user interface 800 may include a diagnosis pane 805. Listed in the diagnosis pane are a diagnosis 810 and a diagnosis 815, for example. Diagnoses that appear in the diagnosis pane 805 may be selected by processes or methods discussed in reference to FIG. 6 and FIG. 7. The diagnosis pane 805 also includes a raw risk score button 820. This raw risk score button 820 may be selected when the user wants the raw risk score to be calculated or recalculated. In some embodiments, the raw risk score may be calculated automatically and the button may only be pushed if the diagnoses appearing in the diagnosis pane 805 have changed, thus necessitating a recalculation. In another embodiment, a raw risk score button 820 may not be present at all, and the raw risk score may be calculated automatically based on whichever diagnoses are currently present in the diagnosis pane 805.

Regardless of how the raw risk score button 820 functions, the diagnosis pane 805 also includes a raw risk score display 825. In the current embodiment, the raw risk score is displayed as 0.948, calculated based on the diagnoses selected in the diagnosis pane 805. In one embodiment, the raw risk score display may include an indicator of whether the raw risk score is high or low. For example, the raw risk score display 825 may appear with a green background if the raw risk score is greater than 1. In another example, the raw risk score display 825 may appear with a red background if the raw risk score is less than 1.

In addition to the diagnosis pane 805, the user interface includes a complexity rating pane 830, a visit type selection button 835, and a generate PM billing button 840. The complexity rating pane 830 allows a user to select how complex the medical decision making was for determining the particular diagnoses. The visit type selection button 835 allows a user to select what type of visit or patient is related to the selected diagnoses in the diagnosis pane 805. The generate PM billing button 840 allows a user to generate a billing using the selected diagnoses in the diagnosis pane 805.

In another illustrative embodiment, a system may flag patients with low health risk scores. This may allow the physician, billing staff-person, or other user in a health care provider to perform a comprehensive review of the diagnoses for each patient to ensure that accurate coding was done. For example, a low health risk score may be defined as a raw risk score of less than 1. In another embodiment, the low health risk score may be defined as a raw risk score of less than 0.75. This may allow a health care provider to choose an optimal code with the highest risk score that best describes the patient's illness.

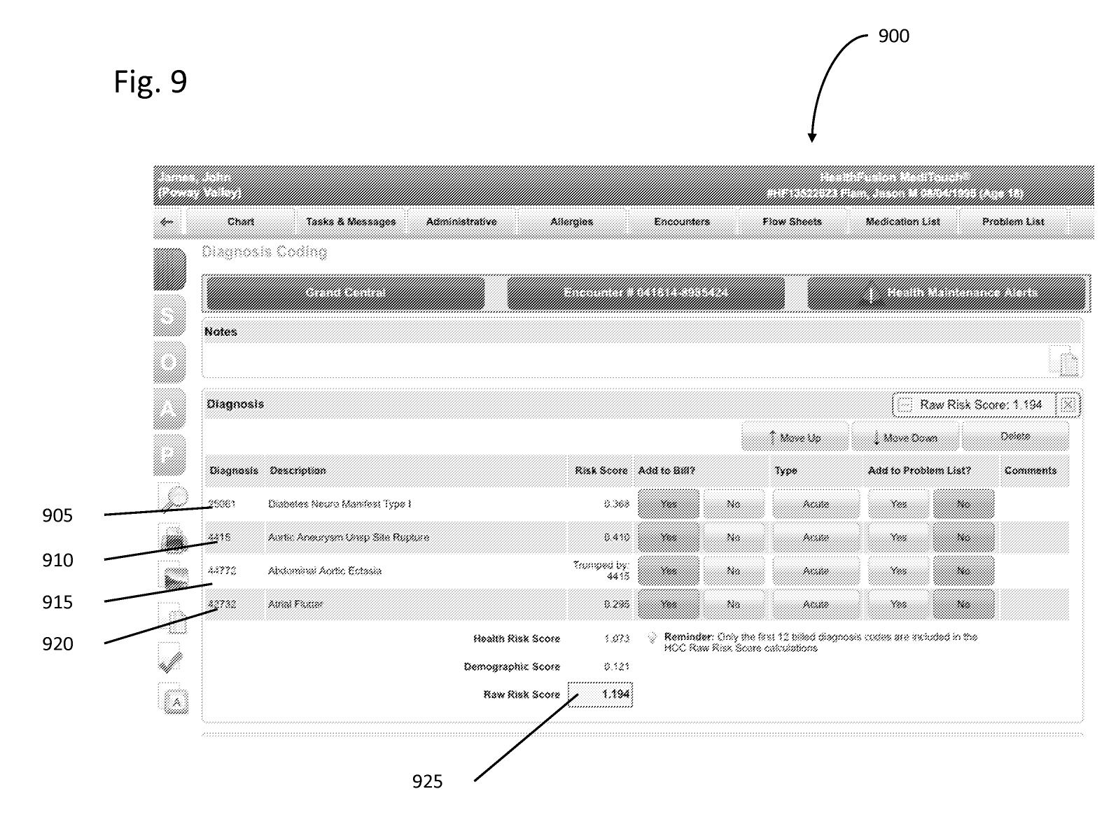

FIG. 9 is another figure representing a user interface 900 that shows selected diagnoses and a calculated raw risk score in accordance with an illustrative embodiment. The user interface 900 includes a first selected diagnosis 905. The first selected diagnosis 905 is Diabetes Neuro Manifest Type 1. In this embodiment, the first selected diagnosis 905 is included in the bill, although in other embodiments a user may toggle the yes and no buttons with respect to the first selected diagnosis 905 to take it off the bill. The first selected diagnosis 905 in this diagnosis is not selected as an acute condition and has not been added to a problem list. In another embodiment, a user may toggle the acute button to designate the first selected diagnosis 905 as acute, and may also add the first selected diagnosis to the problem list.

The first selected diagnosis 905 is associated with a risk score of 0.368, as displayed on the user interface 900. The user interface 900 also includes a second selected diagnosis 910, Aortic Aneurysm Unsp Site Rupture. The second selected diagnosis 910 is associated with a risk score of 0.410, as displayed on the user interface 900. The user interface 900 also includes a third selected diagnosis 915, Abdominal Aortic Ectasia. The third selected diagnosis 915 is associated with a risk score, but it is not displayed on the user interface 900 because the condition is trumped or superseded by the second selected diagnosis 910. The user interface 900 also includes a fourth selected diagnosis 920, Atrial Flutter. The fourth selected diagnosis 920 is associated with a risk score of 0.295, as displayed on the user interface 900.

The user interface 900 also includes a raw risk score calculation 925. The raw risk score calculation 925 is calculated by adding the displayed demographic score and the displayed health risk score. The displayed health risk score is calculated by adding together all of the selected diagnoses, in this case the first selected diagnosis 905, the second selected diagnosis 910, and the fourth selected diagnosis 920. In this embodiment, the box around the raw risk score calculation 925 is colored to indicate something about the raw risk score. For example, the box may be colored green if the raw risk score is above a certain threshold. In this embodiment, the raw risk score is above one, so the box may be colored green. If the raw risk score was below one, the box may be colored red. If the raw risk score was exactly one, it may be colored white. In other embodiments, other colors, patterns, or fonts may be used to indicate that the raw risk score is above or below any number of thresholds.

In an illustrative embodiment, any of the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus comprising:
a memory; and
a processor coupled to the memory, wherein the processor is configured to:
receive a diagnosis input, wherein the diagnosis input represents a condition of a patient;
identify a health risk value in a data file stored in the memory using the diagnosis input, wherein in the data file the diagnosis input is associated with the health risk value, and wherein the health risk value is a numerical risk factor that represents an increased risk of treating the patient with the condition; and
calculate a raw risk score based at least in part on the health risk value, wherein the raw risk score indicates a multiplier that is used at least in part to determine payments to a health care plan.

2. The apparatus of claim 1, wherein the processor is further configured to:
receive a demographic input, wherein the demographic input represents at least one demographic trait of the patient;
identify a demographic risk value in the data file stored in the memory using the demographic input, wherein in the data file the demographic input is associated with the demographic risk value, and wherein the demographic risk value is a second numerical risk factor that represents a further increased risk of treating the patient with the at least one demographic trait; and
calculate the raw risk score based at least in part on the demographic risk value.

3. The apparatus of claim 2, wherein the processor is further configured to calculate the raw risk score by combining the health risk value and the demographic risk value.

4. The apparatus of claim 1, wherein the processor is further configured to:
receive an alphanumeric sequence of characters;
identify at least one of a plurality of possible diagnosis inputs stored in the memory, wherein the at least one possible diagnosis input is identified based on its similarity to the alphanumeric sequence of characters; and
receive a selection of the at least one possible diagnosis input, wherein the selection represents the diagnosis input.

5. The apparatus of claim 4, wherein the processor is further configured to identify a suggested diagnosis, wherein the suggested diagnosis is a similar disease type to the at least one possible diagnosis input.

6. The apparatus of claim 4, wherein the processor is further configured to identify a possible diagnosis input health risk value, wherein the possible diagnosis input health risk value is a second numerical risk factor that represents a second increased risk of treating the patient with a possible diagnosis associated with the at least one possible diagnosis input.

7. The apparatus of claim 4, wherein the processor is further configured to display, on a visual display, a possible diagnosis input health risk indicator, wherein the possible diagnosis input health risk indicator is a numerical value that represents an increased risk of treating the patient with a possible diagnosis associated with the at least one possible diagnosis input.

8. A method comprising:
receiving, by a processor of a computing device, a diagnosis input, wherein the diagnosis input represents a condition of a patient;
identifying, by the processor of the computing device, a health risk value in a data file stored in a memory using the diagnosis input, wherein in the data file the diagnosis input is associated with the health risk value, and wherein the health risk value is a numerical risk factor that represents an increased risk of treating the patient with the condition; and
calculating, by the processor of the computing device, a raw risk score based at least in part on the health risk value, wherein the raw risk score indicates a multiplier that is used at least in part to determine payments to a health care plan.

9. The method of claim 8, further comprising:
receiving, by the processor, a second diagnosis input, wherein the second diagnosis input represents a second condition of the patient;
identifying, by the processor, a second health risk value in the data file, wherein in the data file the second diagnosis input is associated with the second health risk value, and wherein the second health risk value is a numerical risk factor that represents an increased risk of treating the patient with the second condition; and
calculating, by the processor, the raw risk score based at least in part on the second health risk value.

10. The method of claim 9, further comprising calculating, by the processor, the raw risk score, wherein the raw risk score is calculated by combining the second health risk value and the health risk value.

11. The method of claim 9, further comprising:
determining, by the processor, that the second health risk value supersedes the health risk value;
calculating, by the processor, the raw risk score, wherein the raw risk score is calculated by using the second health risk value and the health risk value, wherein the health risk value is set to zero.

12. The method of claim 9, further comprising:
receiving, by the processor, a demographic input, wherein the demographic input represents at least one demographic trait of the patient; and
identifying, by the processor, a demographic risk value in the data file, wherein in the data file the demographic input is associated with the demographic risk value, and wherein the demographic risk value is a numerical risk factor that represents a further increased risk of treating the patient with the at least one demographic trait.

13. The method of claim 12, further comprising calculating, by the processor, a raw risk score, wherein the raw risk score is calculated by combining the second health risk value, the health risk value, and the demographic risk value.

14. The method of claim 12, further comprising:
determining, by the processor, that the second health risk value supersedes the health risk value;
calculating, by the processor, the raw risk score, wherein the raw risk score is calculated by combining the second health risk value, the health risk value, and the demographic risk value, and wherein the health risk value is set to zero.

15. A non-transitory computer readable medium having instructions stored thereon for execution by a processor, the instructions comprising:
instructions to receive, by the processor, a diagnosis input, wherein the diagnosis input represents a condition of a patient;
instructions to identify, by the processor, a health risk value in a data file stored in a memory using the diagnosis input, wherein in the data file the diagnosis input is associated with the health risk value, and wherein the health risk value is a numerical risk factor that represents an increased risk of treating the patient with the condition; and
instructions to calculate, by the processor, a raw risk score based at least in part on the health risk value, wherein the raw risk score indicates a multiplier that is used at least in part to determine payments to a health care plan.

16. The non-transitory computer readable medium of claim 15, further comprising:
instructions to identify, by the processor, a historical condition, wherein the historical condition represents a past diagnosis related to the patient; and
instructions to receive, by the processor, a selection of the historical condition, wherein the selection of the historical condition is the received diagnosis input.

17. The non-transitory computer readable medium of claim 15, further comprising instructions to identify, by the processor, a suggested diagnosis, wherein the suggested diagnosis is a similar disease type to the diagnosis input.

18. The non-transitory computer readable medium of claim 17, further comprising instructions to receive, by the processor, a suggested diagnosis input, wherein the suggested diagnosis input represents a selection of the suggested diagnosis.

19. The non-transitory computer readable medium of claim 18, further comprising:
instructions to identify, by the processor, a suggested diagnosis risk value in the data file, wherein in the data file the suggested diagnosis input is associated with the suggested diagnosis risk value, and wherein the suggested diagnosis risk value is a second numerical risk factor that represents a further increased risk of treating the patient with the condition or a second condition;
instructions to calculate, by the processor, the raw risk score based at least in part on the suggested diagnosis risk value.

20. The non-transitory computer readable medium of claim 15, wherein the diagnosis input is a numerical code referring to the condition.
